(19) United States
(12) Patent Application Publication
(10) Pub. No.: US 2026/0088983 A1
(43) Pub. Date: Mar. 26, 2026

(54) METHOD AND APPARATUS FOR PROTECTING CRYPTOGRAPHIC KEYS IN THE PROCESS OF MIGRATION TO POST-QUANTUM CRYPTOGRAPHY

(71) Applicant: ARRIS Enterprises LLC, Horsham, PA (US)

(72) Inventors: Xin QIU, San Deigo, CA (US); Yiqun YIN, Riverside, CT (US); James Jian NI, Escondido, CA (US); Oscar JIANG, West Covina, CA (US)

(73) Assignee: ARRIS Enterprises LLC, Horsham, PA (US)

(21) Appl. No.: 19/336,026

(22) Filed: Sep. 22, 2025

Related U.S. Application Data
(60) Provisional application No. 63/698,400, filed on Sep. 24, 2024.
(60) Provisional application No. 63/779,834, filed on Mar. 28, 2025.

(51) Int. Cl. H04L 9/08; G06F 21/57; H04L 9/32

(52) U.S. Cl. CPC H04L 9/0858; G06F 21/575; H04L 9/0894; H04L 9/3268

(57) ABSTRACT

A method and apparatus for securing a device to operate in a post quantum computing environment is disclosed. In one embodiment, the method comprises a first stage of performing a secure boot of the processor, using the pre-provisioned, protected symmetric boot key, a second stage of generating, by the processor, at least one post quantum cryptography (PQC) key pair having a PQC private key and a PQC public key; encrypting the PQC private key according to the pre-provisioned protected symmetric key, storing the encrypted PQC private key in the secure memory, generating a request having the PQC public key; and transmitting the request to an agency external to the processor. A third stage of deploying PQC safe applications is also disclosed.

### CROSS-REFERENCE TO RELATED APPLICATIONS

This application claims benefit of the following, both of which are incorporated by reference herein:

U.S. Provisional Patent Application No. 63/698,400 , entitled “NEW MECHANISMS FOR PROTECTING CRYPTOGRAPHIC KEYS IN THE PROCESS OF MIGRATION TO POST-QUANTUM CRYPTOGRAPHY (PQC),” by Xin Qiu, Yiqun Yin, James Jian Ni, and Oscar Jiang, filed Sep. 24, 2024; and

U.S. Provisional Patent Application No. 63/779,834 , entitled “NEW MECHANISMS FOR PROTECTING CRYPTOGRAPHIC KEYS IN THE PROCESS OF MIGRATION TO POST-QUANTUM CRYPTOGRAPHY (PQC),” by Xin Qiu, Yiqun Yin, James Jian Ni, and Oscar Jiang, filed Mar. 28, 2025.

### BACKGROUND

### 1. Field

The present disclosure relates to systems and methods for protecting digital data.

### 2. Description of the Related Art

Asymmetric key cryptography, known as public key cryptography, uses a pair of keys (a public key and a private key) for encryption and decryption. The public key can be freely shared, but the private key is kept secret. The public key and the private key are mathematically linked, but if they are of sufficient size, it is assumed to be computationally infeasible to derive the private key from the public key. That assumption may change with the advent of quantum computing.

Quantum computing is a type of computation that harnesses the principles of quantum mechanics to solve complex problems. Unlike classical computers that use bits (0 or 1), quantum computers use qubits which can exist in a superposition of states (both 0 and 1 simultaneously). This allows quantum computers to explore a vast number of possibilities concurrently, potentially enabling them to tackle problems that are intractable for even the most powerful supercomputers.

As quantum computing technology advances, transitioning to Post-Quantum Cryptography (PQC) be-comes essential to maintain robust security for software, communications, and data. Traditional public key cryptographic algorithms like RSA, Diffie-Hellman (DH), and Elliptic Curve Cryptography (ECC) are becoming increasingly vulnerable. Quantum computers, once fully realized, will have the potential to break these algorithms within the next 5-10 years, driving the need for a timely transition to a PQC environment.

One of the primary challenges during this transition is to ensure interoperability across a wide spectrum of applications, from infrastructure to end devices. PQC-ready security chips are not expected to be widely available in the near term due to the substantial differences between PQC algorithms and traditional public-key algorithms. PQC algorithms bring notable increases in software footprint, signature sizes, ciphertext sizes, key sizes, and computational demands. These factors present significant challenges in designing new hardware, with additional considerations for firmware, hard-ware/firmware trade-offs, processing power, memory design and access, interfaces, and more, all of which are required to achieve acceptable performance.

While PQC-ready chips and hardware are in development, they are not available at a commercial scale. Key issues with regard to such hardware include constraints such as algorithm complexity, lower level code optimization, and tooling gaps. With regard to algorithm complexity, post quantum algorithms are more complex than classical cryptography, requiring larger key sizes and new mathematics that do not align well with existing hardware. Further, running PQC algorithms efficiently on constrained platforms demands low-level optimization, such as assembly tuning and custom memory management. Such efforts are time consuming and still in the early stages. Finally, with respect to tooling gaps, the ecosystem is not fully prepared because PQC-ready development kids and tools from hardware vendors are still under development and currently unavailable. Thus, there is a gap in the toolchain, slowing down development and validation.

For existing devices, particularly in the IoT and embedded system fields, transitioning to PQC can be even more complex. Many of these devices have long life expectancies (10-15+ years) and were not designed with cryptographic agility in mind. Many of such devices also have high replacement costs. Further IoT devices may not be capable of receiving in-field software up-dates to support PQC, leaving them vulnerable to quantum-based attacks. Even in situations where software updates are possible, securely provisioning unique credentials to individual devices in the field remains a challenge.

The lack of widely available PQC-ready hardware means that simply swapping algorithms is not enough—upgrades may require retrofitting hardware or, in some cases, replacing entire systems. Historically cryptographic migrations like MD5 to SHA or DES to AES took years to complete, and those were relatively smaller in scope. PQC is a much larger shift, affecting all devices and nearly every layer of our digital infrastructure. Keeping security adaptable to future threats without disrupting core functions and services requires balancing flexibility with stability.

In summary, while Post-Quantum Cryptography does not require quantum computers for its implementation, transitioning to PQC over the next decade is critical but far from straightforward. Beyond adopting new algorithms, the process involves overcoming complex challenges in hardware design, system updates, and secure provisioning while ensuring interoperability with both existing and future infrastructure. All of these challenges must be addressed to safeguard against the imminent threat posed by quantum computing.

### SUMMARY

To address the requirements described above, this document discloses a system and method for securing devices in a post PQC environment.

In one embodiment, the method comprises performing a secure boot of the processor, using the pre-provisioned, protected symmetric boot key, generating, by the processor, at least one post quantum cryptography (PQC) key pair having a PQC private key and a PQC public key; encrypting the PQC private key according to the pre-provisioned protected symmetric key, storing the encrypted PQC private key in the secure memory, generating a request having the PQC public key; and transmitting the request to an agency external to the processor. The secure boot of the processor may be accomplished by performing firmware boot instructions with the processor, the firmware boot instructions including instructions for loading at least a portion of the boot code, and boot code verification data into a memory, and verifying the loaded at least of portion of the boot code according to the pre-provisioned protected symmetric boot key and the boot code verification data. In one embodiment the private key of the PQC key pair is generated using a random number generator native to the processor.

Another embodiment is evidenced by an apparatus having a processor and a communicatively coupled memory storing processor instructions for performing the foregoing operations.

The features, functions, and advantages that have been discussed can be achieved independently in various embodiments of the present invention or may be combined in yet other embodiments, further details of which can be seen with reference to the following description and drawings.

### BRIEF DESCRIPTION OF THE DRAWINGS

Referring now to the drawings in which like reference numbers represent corresponding parts throughout:

FIG. 1A is a diagram illustrating the three stage PQC migration framework;

FIG. 1B is a diagram illustrating a target processing device and associated architectural elements;

FIG. 2A is a diagram illustrating one embodiment of how the device may be securely used to perform operations in a PQC environment;

FIG. 2B is a diagram illustrating exemplary operations that can be used to generate a PQC key pair;

FIG. 3 is a diagram illustrating exemplary operations that can be used to provision one or more unique device keys to the device;

FIG. 4 is a diagram illustrating one embodiment of how the symmetric unique device key may be used to transmit data to the device; and

FIG. 5 is a diagram illustrating an exemplary computer system that could be used to implement processing elements of the system.

### DESCRIPTION

In the following description, reference is made to the accompanying drawings which form a part hereof, and which is shown, by way of illustration, several embodiments. It is understood that other embodiments may be utilized and structural changes may be made without departing from the scope of the present disclosure.

### Overview

While public-key cryptographic algorithms like RSA, Diffie-Hellman, and ECC are vulnerable to attacks by quantum computers, symmetric key algorithms, such as AES (Advanced Encryption Standard), are far more resilient to quantum threats.

For example, AES-256, under quantum attacks, would still offer 128-bit security in the classical sense. This is considered sufficiently strong for most real-world applications. Therefore, current symmetric encryption remains a viable and trusted method to protect sensitive data in a post-quantum world.

One important use case for symmetric encryption during the PQC transition process is to protect private keys or other sensitive keys (like code verification keys, which often are required to be immutable) used in PQC algorithms.

A subtle yet critical distinction should be made between protecting sensitive keys “at rest” and keys “in transit.” When securing keys at rest, the AES key used for encryption and decryption often re-mains within the same device, without the need to share it with other entities. This simplifies key management, as there is no need for secure distribution of encryption keys across different parties, unlike in the case of keys in transit. Note that, generally speaking, private keys are sensitive information “at rest. ”

By combining PQC algorithms with robust symmetric encryption for protecting PQC's private/sensitive keys, we can create a multi-layered approach to security, offering enhanced resilience against both classical and quantum threats. This hybrid approach allows existing symmetric algorithms like AES to continue playing a critical role in securing cryptographic systems during the transition to post-quantum environments.

Furthermore, even in today's resource-constrained devices, many have built-in AES engines. Thanks to the relatively small key sizes of AES, it requires minimal secure storage, and hardware-based AES encryption provides excellent performance. We can leverage such AES engines to develop cost-effective PQC-based chips with acceptable performance and security in the future.

To address the foregoing issues, a three-stage PQC migration framework that relies exclusively on symmetric cryptographic techniques is described below. This approach avoids the use of conventional asymmetric cryptography (e.g., RSA, ECC, current TLS protocols) during the transitional stages of the PQC migration framework, due to the potential risk of “harvest now, decrypt later” attacks.

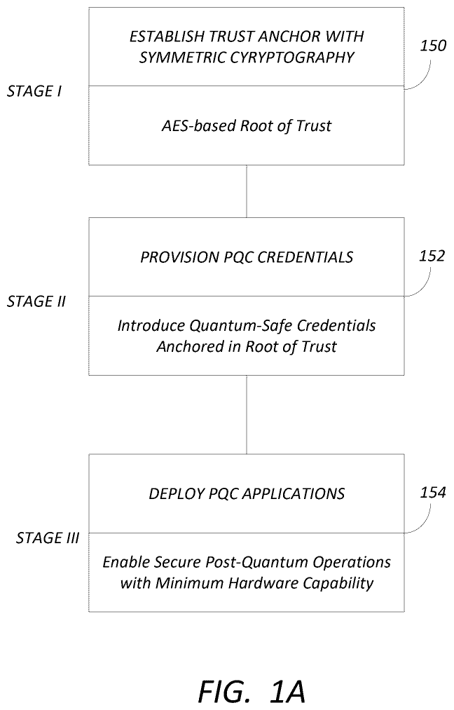

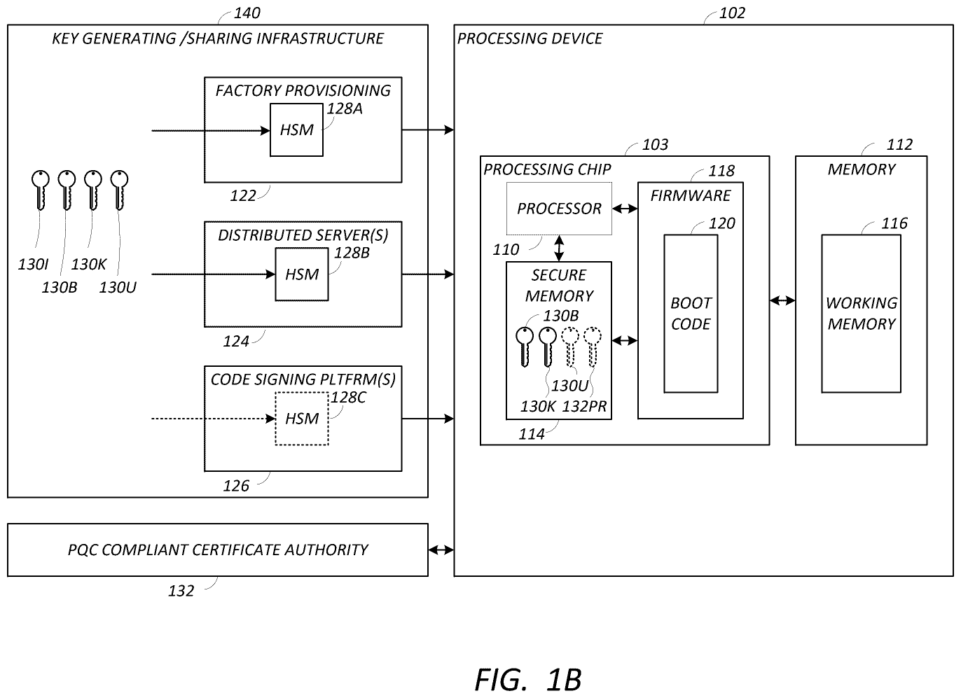

FIG. 1A is a diagram illustrating the three stage PQC migration framework. In Stage I 150, a trust anchor is established using symmetric cryptography. This lays the foundation for further stages by providing an AES-based root of trust. A pre-shared AES key (a pre-provisioned, protected symmetric boot key) is stored in a secure memory of the device. This AES key is shared with a key infrastructure and is used to manage keys and control access from the key infrastructure to enforce security policies and trust.

In Stage II 152, PQC (post quantum cryptography) safe credentials are provided to the device. This is accomplished by securely downloading and installing PQC credential provisioning software to the device using the secure boot capability provided in stage I 150. The PQC credential provisioning software is then executed to generate the PQC credentials, which include a PQC key pair. The private key of the PQC key pair is then stored in secure storage using the pre-shared AES key for later use.

In Stage III 154, PQC-enabled applications (e.g., applications designed to operate securely in a PQC environment) are securely distributed to the device and installed. This is also accomplished using the root of trust established in Stage I 150 or other trusted information derived there from. The PQC credentials provisioned in Stage II 152 are then used to enable secure communication with the device and data protection. In this stage, other AES symmetric keys may be provided to the device as well.

FIG. 1B is a diagram illustrating a target processing device 102 and associated architectural elements. The processing device 102 includes a processing chip 103 having a processor 110 communicatively coupled to a memory 112, which may include a working memory 116. The processing chip includes firmware 118 having boot code 120, and a secure memory 114. The secure memory 114 is read and write protected, so that the memory cannot be read from or written to by an unauthorized entity. The secure memory stores one or more symmetric keys 130 and may also be used to store the private keys 131 of asymmetric key pairs, the private keys being typically generated by the processing device 102. The symmetric keys may be embodied by one or more immutable AES keys of the types described below.

### Key Types

The PQC migration framework relies on symmetric keys, which may be one or more of four types: infrastructure keys, secure boot keys, key provisioning keys, and unique device keys.

Infrastructure keys 130I are used in a key generating/sharing infrastructure 140 that includes one or more factory provisioning facilities 122 as well as one or mor distributed servers 124. Infrastructure keys 130I are created by a multi-party controlled key ceremony process, and are typically loaded and securely stored in a Federal Information Processing Standard) (FIPS) certified hardware security module (HSM) 128, and later provided to one or more a factory provisioning facilities 102 for pre-provisioning into the device 102 using HSM 128A, and may also be provisioned to, distributed servers 124 using HSM 128B.

Secure boot keys 130B are used when the processing device 102 executes a secure boot using boot code 120. Boot code 120 is a small portion of software that initiates the startup process of the processing device 102. It is the first code executed when the processing device 102 resets or is powered on. The primary role of the boot code 120 is to execute operations needed to load the operating system into the working memory 116, but the boot code 120 may perform other roles as well.

Secure boot keys 130B are also typically created by a multi-party controlled key ceremony, and loaded into an FIPS-certified HSM 128A for pre-provisioning into the device 102 via the factory provisioning facility 122. Secure boot keys 130B may be specific to a company, product or model family, essentially treating them as a type of global symmetric key. Secure boot keys 130B are generally burned into the chips 103 later installed in processing devices 102 before the processing device 102 is provisioned to the end user, and are stored in the secure (read/write protected) memory 114 of the processing chip 103. Pre-provisioned, protected symmetric boot keys 130B are used as a root of trust for the provision and use of other keys including the key-provisioning keys 130K and unique device keys 130U, and PQC private keys 132PR described below.

Key-provisioning keys 130K are used for provisioning unique device keys 130U, for example, after the processing device 102 has been deployed and is in the field. Such keys are also created using a multi-party controlled ceremony process, and are loaded into FIPS certified HSMs 128A and 128B by the key generation/sharing infrastructure 140. The HSMs 128A and 128B are then used by the using the factory provisioning facility 122 or distributed servers 124 to be loaded into the secure memory 114 of the processing device 102.

Unique device keys 130U are unique to the device 102, device model, device class, or device manufacturer and may include one-time programmable (OTP) keys. Unique device keys 130U are generated by the key generating/sharing infrastructure 140 and may be provided to the factory provisioning facility 122 or distributed servers 124 via loading them into the associated HSM 128A, 128B, or by simply transmitting the keys 130U. The unique device keys 130U are provisioned to individual and specific devices 102, and can be used to provision and protect PQC keys. The symmetric unique device keys 130U can include, for example, keys that are unique to the individual device 102, unique to the model of the device 102, unique to the class of the device 102, or unique to the manufacturer of the device 102. Such unique symmetric device keys 130U can be used to support operations on a manufacturer, model or individual device 102 basis as desired.

In the foregoing discussion, reference is made to protected symmetric keys. Such keys are protected in the sense that they are securely generated by the key generating/sharing infrastructure 130 and provided to the factory provisioning facility 122 or distributed server(s) 124 in secure HSMs 128 before being securely loaded into the secure memory 114 of the device 102 itself. Further, symmetric keys that do not represent the root of trust (e.g., symmetric keys other than the secure boot key 130B) are encrypted before storage in the secure memory 114 and remain encrypted until they are required for further processing. Further, all symmetric keys, when unencrypted for use, are utilized under circumstances that minimize the exposure of these symmetric keys to compromise. For example, such symmetric keys are permitted in working memory 116 only when in active use and deleted or overwritten thereafter.

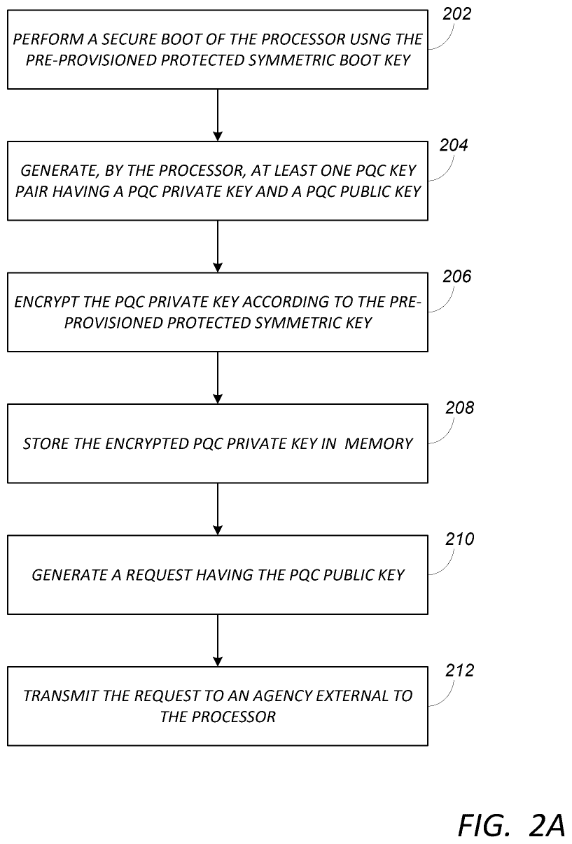

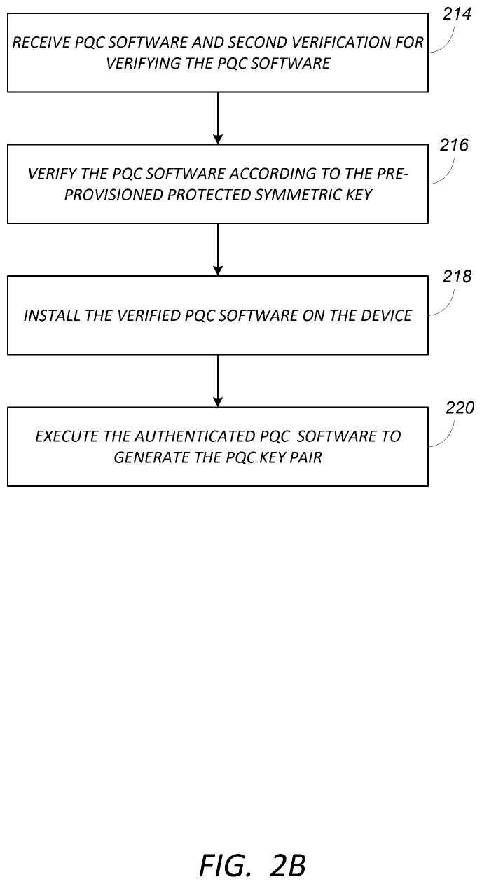

FIG. 2A is a diagram illustrating one embodiment of how the device 102 may be securely used to perform operations in a PQC environment. First, a secure boot of the processor 102 is performed using the pre-provisioned protected symmetric boot key 130B.

This secure boot is accomplished by loading at least a portion of the boot code 120 as well as boot code verification data such as a message authentication code (MAC) or other cryptographic checksum into memory such as working memory 116. The boot code verification data is created at the source of the boot code 120 by operating on the boot code 120 using an algorithm and the secure boot key 130B. The resulting boot code verification data is then appended to the boot code 120 before being provided to the processing device 102.

The processing device 102 loads the boot code 120 and the boot code verification data, and verifies the boot code 120 by using the same algorithm and same symmetric boot key 130B (pre-provisioned to the device and protected by being stored in secure memory 114 before deployment to the end-user) to operate on the boot code 120 to generate a checksum or MAC. If the boot code 120 has not been altered, the value of the resulting checksum or MAC will be the same as the boot code verification data appended to the boot code 120, in which case, the boot code 120 is verified. If the resulting checksum or MAC does not match the boot code verification data appended to the boot code 120, the boot code 120 is unverified, indicating it has been altered or tampered with. Once the boot code 120 has been verified, the device 102 is booted, and the secure boot has been accomplished.

The boot code verification data and symmetric boot key 130B can also be used to support both verification of the boot code 120 and encryption of the boot code itself. This can be accomplished by using the symmetric boot key 130B to encrypt the boot code 120 appended with the verification data before transmission to the device 102. The device 102 then uses the symmetric boot key 130B to decrypt the encrypted boot code 120 appended with the boot code verification data, and then proceeds as described above to use the same algorithm and same symmetric boot key 130B to operate on the boot code 120 to generate a checksum or MAC that is compared to the boot code verification data appended to the boot code 120.

Returning back to FIG. 2A, the processor generates at least one PQC key par having a PQC private key and a PQC public key, as shown in block 204.

FIG. 2B is a diagram illustrating exemplary operations that can be used to generate a PQC key pair. In block 214, the device 102 receives (for example, from distributed server(s) 124 or code signing platform(s) 126 having HSM 128C) PQC software and software verification data. The PQC software includes processing instructions that allow the processing device 102 to generate a PQC key pair.

The PQC software verification data may comprise a MAC or other cryptographic checksum, and is typically appended to the PQC software itself. In block 216, the PQC software is authenticated or verified according to the PQC software verification data and the pre-provisioned protected symmetric boot key 130B. This is accomplished using techniques analogous to those used to verify the boot code 120 as described above. If the PQC software is not verified or authenticated, the PQC software is not installed and an error message may be provided. If the PQC software is verified, the operations of block 218 are performed to install the authenticated PQC software on the device 102, and the authenticated PQC software is executed to generate the PQC key pair, as shown in block 220.

Although the PQC software described in the above example includes instructions for generate a PQC key pair, the PQC software can also perform other functions as well to support PQC operations. Further, other PQC software performing other functions may be downloaded, validated, and executed using the foregoing techniques.

Notably, generating a PQC key pair requires the generation of a random number, and this function may be implemented in the PQC software itself or in a random number generator native to the processor 110 or firmware 118 as provisioned from the factory.

Returning to FIG. 2A, blocks 206 and 208 describe encryption of the PQC private key 132PR using the pre-provisioned protected symmetric boot key 130B, and storing of the encrypted PQC private key 132PR in memory, for example, secure memory 114.

Finally, blocks 210 and 212 describe generating a request having the PQC public key, and transmitting the request to an agency external to the processor. Examples of these operations are presented below.

### Certificate Signing Requests

In a first example, the generated request comprises a certificate signing request having the PQC public key, and the external agency is a certificate authority 134 (preferably, a PQC compliant certificate authority). In response to the request, the device 102 receives a signed digital certificate from the certificate authority 134.

### Key Requests

In a second example, the generated request comprises a request from the device for one or more unique device keys 130U. Delivery of such keys can be accomplished by use of infrastructure keys 130I, and key provisioning keys 130K.

As described above, the symmetric unique device key(s) 130U may be unique to a particular device 102, model of device 102, manufacture of device 102, or other grouping of devices. For example, if the third party wishes to send a software update to every device 102 of a particular model, the symmetric unique device key 130U of interest may be a symmetric unique device key 130U shared by all devices 102 of that model. Similarly, if the third party wishes to send a software update or other data to a single unique device 102, the unique device 130U will be unique to that single device 102.

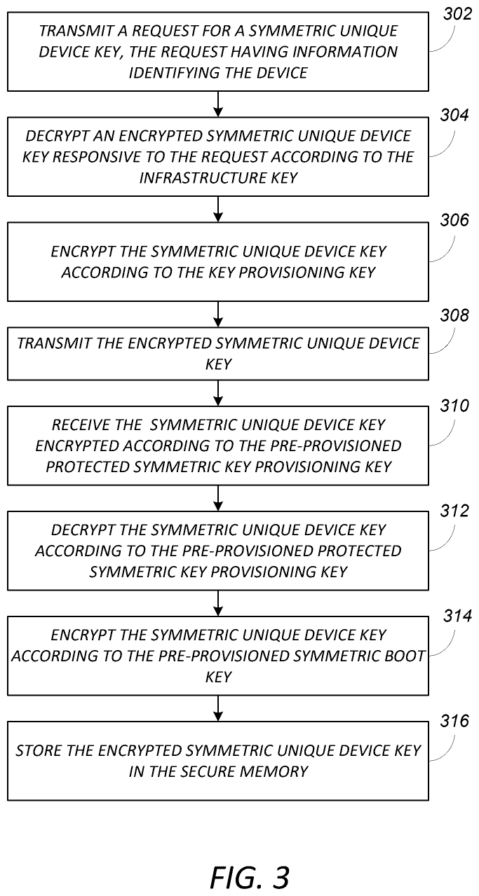

FIG. 3 is a diagram illustrating exemplary operations that can be used to provision one or more unique device keys 130U to the device 102. In this embodiment, symmetric key provisioning key 130K has been pre-provisioned to the device 102 and is protected by storage in the secure memory 114. As described above, the pre-provisioned protected symmetric key provisioning key can be created by a multi-party controlled key ceremony, and stored in a hardware security module 128A of the factory provisioning facility 122. The symmetric key provisioning key 130K is then pre-provisioned (e.g., provided before deployment to the end user) by secure transfer from the HSM 128 to the secure memory 114 of the device 102 itself. The key provisioning key 130U may be global or specific to particular devices 120 or device classes.

The process begins (preferably before any requests for keys) with the key generating/sharing infrastructure 140 storing infrastructure keys 130I and key-provisioning keys 130K on a server HSM 128B. A set of unique symmetric keys 130U are generated offline and each generated unique symmetric key 130U is encrypted with the infrastructure key 130I. These encrypted unique symmetric keys 130U are then stored in a memory of the distributed server 124.

As shown in FIG. 3, a request for a symmetric unique device key 130U is transmitted from the device 102 (or an agent of the device 102), the request having an identifier of the device 102. The request is received in a distributed server 124, and in response to receiving that request, the server 124 determines which unique device key(s) 130U to provide from the request and the device identifier, retrieves the infrastructure key from the server HSM 128, and decrypts the identified unique device key(s) 130U, as shown in block 304. The server 124 then encrypts the unique device key(s) 130U with the key provisioning key 130K, which may be stored by the server 124 or retrieved from the HSM 128B, as shown in block 306. The encrypted symmetric unique device key(s) 130U are then transmitted to the device 102, as shown in block 308. The device 102 receives the encrypted symmetric unique device key 130U, and decrypts the encrypted symmetric unique device key 130U using the key provisioning key 130K stored in secure memory 114, as shown in blocks 310 and 312. The symmetric unique device key 130U is then encrypted according to the symmetric boot key 130B and stored in memory, for example, secure memory 114 for later use, as shown in blocks 314 and 316.

### Data Requests

In a third example, the generated request comprises a request for data, from a third party or from any of a plurality of distributed servers 124, code signing platforms 126 or other entity. The data itself may comprise, for example, further PQC software or applications, or any other data.

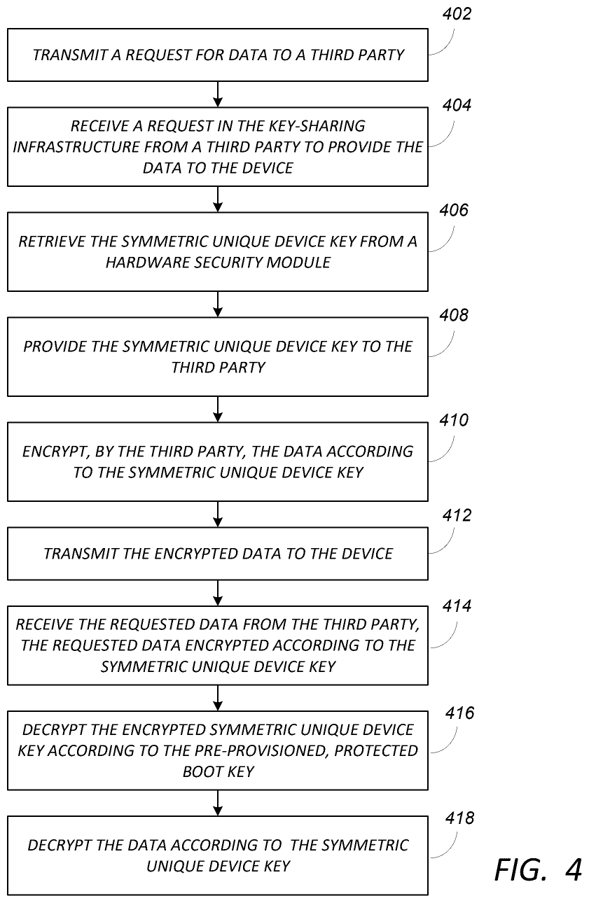

FIG. 4 is a diagram illustrating one embodiment of how the symmetric unique device key 130U may be used to transmit data to the device 102. In block 402, the device 102 transmits a request for data that includes a device 102 identifier. In the illustrated embodiment, the request is transmitted to a third party, and the third party forwards the request to the key sharing infrastructure 140. The key sharing infrastructure 140 receives the request, as shown in block 404. The key sharing infrastructure 140 then determines which symmetric unique device key(s) 130U to retrieve from the server 124 or the HSM 128B (e.g. symmetric unique device key(s) 130U that were previously provisioned to the device 102) and provides those symmetric unique device key(s) 130U to the third party, preferably via a secure channel, as shown in blocks 406 and 408. The third party then encrypts the data according to the symmetric unique device key(s) 130U, and transmits the encrypted data to the device 102, as shown in blocks 410 and 412.

As shown in block 414, the device 102 receives the encrypted requested data from the third party. The device 102 then retrieves the encrypted symmetric unique device key 130, and decrypts that key using the pre-provisioned, protected symmetric boot key 130B. The resulting symmetric unique device key 130U then used to decrypt the data, as shown in block 418.

In some cases, the requested data may comprise software. In such cases, it is important to verify the software before installing the software on the device 102. This can be accomplished via code signing platforms 126, which can use symmetric unique device key(s) 130U to verify such software before the software before installation, using techniques analogous to those described above with respect to the boot code 120.

### Hardware Environment

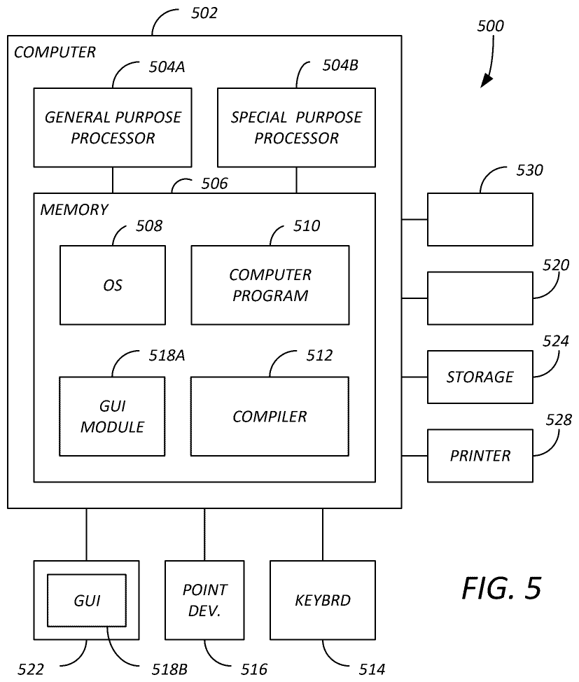

FIG. 5 illustrates an exemplary computer system 800 that could be used to implement processing elements of the above disclosure, including the processing device 102, distributed servers 124, code signing platform 126 and certificate authorities 134. The computer 502 comprises a processor 504 and a memory, such as random access memory (RAM) 506. The computer 502 is operatively coupled to a display 522, which presents images such as windows to the user on a graphical user interface 518B. The computer 502 may be coupled to other devices, such as a keyboard 514, a mouse device 516, a printer 528, etc. Of course, those skilled in the art will recognize that any combination of the above components, or any number of different components, peripherals, and other devices, may be used with the computer 502.

Generally, the computer 502 operates under control of an operating system 508 stored in the memory 506, and interfaces with the user to accept inputs and commands and to present results through a graphical user interface (GUI) module 518A. Although the GUI module 518B is depicted as a separate module, the instructions performing the GUI functions can be resident or distributed in the operating system 508, the computer program 510, or implemented with special purpose memory and processors. The computer 502 also implements a compiler 512 which allows an application program 510 written in a programming language such as COBOL, C++, FORTRAN, or other language to be translated into processor 504 readable code. After completion, the application 510 accesses and manipulates data stored in the memory 506 of the computer 502 using the relationships and logic that was generated using the compiler 512. The computer 502 also optionally comprises an external communication device such as a modem, satellite link, Ethernet card, or other device for communicating with other computers.

In one embodiment, instructions implementing the operating system 508, the computer program 510, and the compiler 512 are tangibly embodied in a computer-readable medium, e.g., data storage device 520, which could include one or more fixed or removable data storage devices, such as a zip drive, floppy disc drive 524, hard drive, CD-ROM drive, tape drive, etc. Further, the operating system 508 and the computer program 510 are comprised of instructions which, when read and executed by the computer 502, causes the computer 502 to perform the operations herein described. Computer program 510 and/or operating instructions may also be tangibly embodied in memory 506 and/or data communications devices 530, thereby making a computer program product or article of manufacture. As such, the terms “article of manufacture,” “program storage device” and “computer program product” as used herein are intended to encompass a computer program accessible from any computer readable device or media.

Those skilled in the art will recognize many modifications may be made to this configuration without departing from the scope of the present disclosure. For example, those skilled in the art will recognize that any combination of the above components, or any number of different components, peripherals, and other devices, may be used.

### Conclusion

This concludes the description of the preferred embodiments of the present disclosure.

The foregoing description of the preferred embodiment has been presented for the purposes of illustration and description. It is not intended to be exhaustive or to limit the disclosure to the precise form disclosed. Many modifications and variations are possible in light of the above teaching. It is intended that the scope of rights be limited not by this detailed description, but rather by the claims appended hereto.

A method for securing a device having processor, the processor communicatively coupled to a secure memory storing a pre-provisioned, protected symmetric boot key is disclosed. In one embodiment, the system comprises performing a secure boot of the processor, using the pre-provisioned, protected symmetric boot key, comprising: performing boot instructions with the processor, the boot instructions including instructions for: loading at least a portion of the boot code, and boot code verification data into a memory; and verifying the loaded at least of portion of the boot code according to the pre-provisioned protected symmetric boot key and the boot code verification data. The method also comprises generating, by the processor, at least one post quantum cryptography (PQC) key pair having a PQC private key and a PQC public key; encrypting the PQC private key according to the pre-provisioned protected symmetric key; storing the encrypted PQC private key in the secure memory; generating a request having the PQC public key; and transmitting the request to an agency external to the processor.

Implementations may include one or more of the following features.

Any of the above methods, wherein: the request is a certificate signing request and the external agency is a certificate authority; and the method further comprises receiving a signed digital certificate.

Any of the above methods, wherein: generating, by the processor, at least one PQC key pair having a PQC private key and a PQC public key comprises: receiving PQC software and PQC software verification data the PQC software, the PQC software for generating the at least one PQC key pair; authenticating the PQC software according to the pre-provisioned protected symmetric key and the PQC software verification data; installing the authenticated PQC software on the device; and executing the authenticated PQC software to generate the PQC key pair.

Any of the above methods, wherein: the secure memory further stores a pre-provisioned protected symmetric key provisioning key; and the method further comprises: receiving, in the device, a symmetric unique device key encrypted according to the pre-provisioned protected symmetric key provisioning key; decrypting the symmetric unique device key according to the pre-provisioned protected symmetric key provisioning key; encrypting the symmetric unique device key according to the pre-provisioned, protected symmetric boot key; and storing the encrypted symmetric unique device key in the secure memory.

Any of the above methods, wherein: transmitting the request to the agency external to the processor comprises: transmitting a request for data to a third party; and the method further comprises: receiving the requested data from the third party, the requested data encrypted according to the symmetric unique device key; decrypting the symmetric unique device key according to the pre-provisioned, protected symmetric boot key; and decrypting the encrypted requested data according to the symmetric unique device key.

Any of the above methods, further comprising: receiving a request in the key-sharing infrastructure from the third party to provide the data to the device; retrieving the symmetric unique device key from the hardware security module of the key-sharing infrastructure; providing the symmetric unique device key to the third party; encrypting, by the third party, the data according to the symmetric unique device key; and transmitting the encrypted data to the device.

Any of the above methods, wherein: the pre-provisioned protected symmetric key provisioning key is created by a multi-party controlled key ceremony; stored in a hardware security module of a key sharing infrastructure; and pre-provisioned from a hardware security device of the key sharing infrastructure to the secure memory.

Another embodiment is evidenced by a device for performing post quantum cryptography safe operations. In one embodiment, the device comprises: a processor, the processor communicatively coupled to a secure memory storing a pre-provisioned, protected symmetric boot key; a memory, the memory storing processing instructions including processor instructions for performing a secure boot of the processor, using the pre-provisioned, protected symmetric boot key, the processing instructions for performing the secure boot of the processor comprising processor instructions for: loading at least a portion of the boot code, and boot code verification data into a memory; and verifying the loaded at least of portion of the boot code according to the pre-provisioned protected symmetric boot key and the boot code verification data; generating, by the processor, at least one post quantum cryptography (PQC) key pair having a PQC private key and a PQC public key; encrypting the PQC private key according to the pre-provisioned protected symmetric key; storing the encrypted PQC private key in memory; generating a request having the PQC public key; and transmitting the request to an agency external to the processor.

Implementations may include one or more of the following features.

Any of the above devices, wherein: the request is a certificate signing request and the external agency is a certificate authority; and the method further comprises receiving a signed digital certificate.

Any of the above devices, wherein: the processor instructions for generating, by the processor, at least one PQC key pair having a PQC private key and a PQC public key comprise processor instructions for: receiving PQC software and PQC software verification data the PQC software, the PQC software for generating the at least one PQC key pair; authenticating the PQC software according to the pre-provisioned protected symmetric key and the PQC software verification data; installing the authenticated PQC software on the device; and executing the authenticated PQC software to generate the PQC key pair.

Any of the above devices, wherein: the secure memory further stores a pre-provisioned protected symmetric key provisioning key; and the processor instructions further comprise processor instructions for: receiving, in the device, a symmetric unique device key encrypted according to the pre-provisioned protected symmetric key provisioning key; decrypting the symmetric unique device key according to the pre-provisioned protected symmetric key provisioning key; encrypting the symmetric unique device key according to the pre-provisioned, protected symmetric boot key; and storing the encrypted symmetric unique device key in the secure memory.

Any of the above devices, wherein: the processor instructions for transmitting the request to the agency external to the processor comprise: processor instructions for transmitting a request for data to a third party; the processor instructions further comprise processor instructions for: receiving the requested data from the third party, the requested data encrypted according to the symmetric unique device key; decrypting the symmetric unique device key according to the pre-provisioned, protected symmetric boot key; and decrypting the encrypted requested data according to the symmetric unique device key.

Any of the above devices, wherein: the processor instructions further comprise processor instructions for: receiving a request in the key-sharing infrastructure from the third party to provide the data to the device; retrieving the symmetric unique device key from the hardware security module of the key-sharing infrastructure; providing the symmetric unique device key to the third party; encrypting, by the third party, the data according to the symmetric unique device key; and transmitting the encrypted data to the device.

Any of the above devices, wherein: the pre-provisioned protected symmetric key provisioning key is created by a multi-party controlled key ceremony; stored in a hardware security module of a key sharing infrastructure; and pre-provisioned from a hardware security device of the key sharing infrastructure to the secure memory.

What is claimed is:

1. A method of securing a device having processor, the processor communicatively coupled to a secure memory storing a pre-provisioned, protected symmetric boot key, the method comprising:
performing a secure boot of the processor, using the pre-provisioned, protected symmetric boot key, comprising:
performing boot instructions with the processor, the boot instructions including instructions for:
loading at least a portion of the boot code, and boot code verification data into a memory; and
verifying the loaded at least of portion of the boot code according to the pre-provisioned protected symmetric boot key and the boot code verification data;
generating, by the processor, at least one post quantum cryptography (PQC) key pair having a PQC private key and a PQC public key;
encrypting the PQC private key according to the pre-provisioned protected symmetric key;
storing the encrypted PQC private key in the secure memory;
generating a request having the PQC public key; and
transmitting the request to an agency external to the processor.

2. The method of claim 1, wherein:
the request is a certificate signing request and the external agency is a certificate authority; and
the method further comprises receiving a signed digital certificate.

3. The method of claim 1, wherein:
generating, by the processor, at least one PQC key pair having a PQC private key and a PQC public key comprises:
receiving PQC software and PQC software verification data the PQC software, the PQC software for generating the at least one PQC key pair;
authenticating the PQC software according to the pre-provisioned protected symmetric key and the PQC software verification data;
installing the authenticated PQC software on the device; and
executing the authenticated PQC software to generate the PQC key pair.

4. The method of claim 1, wherein:
the secure memory further stores a pre-provisioned protected symmetric key provisioning key; and
the method further comprises:
receiving, in the device, a symmetric unique device key encrypted according to the pre-provisioned protected symmetric key provisioning key;
decrypting the symmetric unique device key according to the pre-provisioned protected symmetric key provisioning key;
encrypting the symmetric unique device key according to the pre-provisioned, protected symmetric boot key; and
storing the encrypted symmetric unique device key in the secure memory.

5. The method of claim 4, wherein:
transmitting the request to the agency external to the processor comprises:
transmitting a request for data to a third party;
the method further comprises:
receiving the requested data from the third party, the requested data encrypted according to the symmetric unique device key;
decrypting the symmetric unique device key according to the pre-provisioned, protected symmetric boot key; and
decrypting the encrypted requested data according to the symmetric unique device key.

6. The method of claim 5, further comprising:
receiving a request in the key-sharing infrastructure from the third party to provide the data to the device;
retrieving the symmetric unique device key from the hardware security module of the key-sharing infrastructure;
providing the symmetric unique device key to the third party;
encrypting, by the third party, the data according to the symmetric unique device key; and
transmitting the encrypted data to the device.

7. The method of claim 6, wherein the pre-provisioned protected symmetric key provisioning key is:
created by a multi-party controlled key ceremony;
stored in a hardware security module of a key sharing infrastructure; and
pre-provisioned from a hardware security device of the key sharing infrastructure to the secure memory.

8. A device for performing post quantum cryptography safe operations, comprising:
a processor, the processor communicatively coupled to a secure memory storing a pre-provisioned, protected symmetric boot key;
a memory, the memory storing processing instructions including processor instructions for
performing a secure boot of the processor, using the pre-provisioned, protected symmetric boot key, the processing instructions for performing the secure boot of the processor comprising processor instructions for:
loading at least a portion of the boot code, and boot code verification data into a memory; and
verifying the loaded at least of portion of the boot code according to the pre-provisioned protected symmetric boot key and the boot code verification data;
generating, by the processor, at least one post quantum cryptography (PQC) key pair having a PQC private key and a PQC public key;
encrypting the PQC private key according to the pre-provisioned protected symmetric key;
storing the encrypted PQC private key in the secure memory;
generating a request having the PQC public key; and
transmitting the request to an agency external to the processor.

9. The device of claim 8, wherein:
the request is a certificate signing request and the external agency is a certificate authority; and
the method further comprises receiving a signed digital certificate.

10. The device of claim 8, wherein:
the processor instructions for generating, by the processor, at least one PQC key pair having a PQC private key and a PQC public key comprise processor instructions for:
receiving PQC software and PQC software verification data the PQC software, the PQC software for generating the at least one PQC key pair;
authenticating the PQC software according to the pre-provisioned protected symmetric key and the PQC software verification data;
installing the authenticated PQC software on the device; and
executing the authenticated PQC software to generate the PQC key pair.

11. The device of claim 8, wherein:
the secure memory further stores a pre-provisioned protected symmetric key provisioning key;
the processor instructions further comprise processor instructions for:
receiving, in the device, a symmetric unique device key encrypted according to the pre-provisioned protected symmetric key provisioning key;
decrypting the symmetric unique device key according to the pre-provisioned protected symmetric key provisioning key;
encrypting the symmetric unique device key according to the pre-provisioned, protected symmetric boot key; and
storing the encrypted symmetric unique device key in the secure memory.

12. The device of claim 11, wherein:
the processor instructions for transmitting the request to the agency external to the processor comprise:
processor instructions for transmitting a request for data to a third party;
the processor instructions further comprise processor instructions for:
receiving the requested data from the third party, the requested data encrypted according to the symmetric unique device key; and
decrypting the symmetric unique device key according to the pre-provisioned, protected symmetric boot key; and
decrypting the encrypted requested data according to the symmetric unique device key.

13. The device of claim 12, wherein the processor instructions further comprise processor instructions for:
receiving a request in the key-sharing infrastructure from the third party to provide the data to the device;
retrieving the symmetric unique device key from the hardware security module of the key-sharing infrastructure;
providing the symmetric unique device key to the third party;
encrypting, by the third party, the data according to the symmetric unique device key; and
transmitting the encrypted data to the device.

14. The device of claim 13, wherein the pre-provisioned protected symmetric key provisioning key is:
created by a multi-party controlled key ceremony;
stored in a hardware security module of a key sharing infrastructure; and
pre-provisioned from a hardware security device of the key sharing infrastructure to the secure memory.

15. A system securing a device having processor, the processor communicatively coupled to a secure memory storing a pre-provisioned, protected symmetric boot key, the method comprising:
means for performing a secure boot of the processor, using the pre-provisioned, protected symmetric boot key, comprising:
means for performing boot instructions, the boot instructions including instructions for:
loading at least a portion of the boot code, and boot code verification data into a memory; and
verifying the loaded at least of portion of the boot code according to the pre-provisioned protected symmetric boot key and the boot code verification data;
means for generating at least one post quantum cryptography (PQC) key pair having a PQC private key and a PQC public key;
means for encrypting the PQC private key according to the pre-provisioned protected symmetric key;
means for storing the encrypted PQC private key in the secure memory;
means for generating a request having the PQC public key; and
means for transmitting the request to an agency external to the processor.

16. The system of claim 15, wherein:
the request is a certificate signing request and the external agency is a certificate authority; and
the system further comprises means for receiving a signed digital certificate.

17. The system of claim 15, wherein:
the means for generating, by the processor, at least one PQC key pair having a PQC private key and a PQC public key comprises:
means for receiving PQC software and PQC software verification data the PQC software, the PQC software for generating the at least one PQC key pair;
means for authenticating the PQC software according to the pre-provisioned protected symmetric key and the PQC software verification data;
means for installing the authenticated PQC software on the device; and
means for executing the authenticated PQC software to generate the PQC key pair.

18. The system of claim 15, wherein:
the secure memory further stores a pre-provisioned protected symmetric key provisioning key;
the system further comprises:
means for receiving, in the device, a symmetric unique device key encrypted according to the pre-provisioned protected symmetric key provisioning key;
means for decrypting the symmetric unique device key according to the pre-provisioned protected symmetric key provisioning key;
means for encrypting the symmetric unique device key according to the pre-provisioned, protected symmetric boot key; and
means for storing the encrypted symmetric unique device key in the secure memory.

19. The means for of claim 18, wherein:
the means for transmitting the request to the agency external to the processor comprises:
means for transmitting a request for data to a third party;
the system further comprises:
means for receiving the requested data from the third party, the requested data encrypted according to the symmetric unique device key; and
means for decrypting the symmetric unique device key according to the pre-provisioned, protected symmetric boot key; and
means for decrypting the encrypted requested data according to the symmetric unique device key.

20. The system of claim 19, further comprising:
means for receiving a request in the key-sharing infrastructure from the third party to provide the data to the device;
means for retrieving the symmetric unique device key from the hardware security module of the key-sharing infrastructure;
means for providing the symmetric unique device key to the third party;
means for encrypting, by the third party, the data according to the symmetric unique device key; and
means for transmitting the encrypted data to the device.
